(19) United States
(12) Patent Application Publication
(10) Pub. No.: US 2013/0339001 A1
(43) Pub. Date: Dec. 19, 2013

(54) SPELLING CANDIDATE GENERATION

(71) Applicants: NICHOLAS ERIC CRASWELL, Seattle, WA (US); NITIN AGRAWAL, Redmond, WA (US); BODO von BILLERBECK, Melbourne (AU); HUSSEIN MOHAMED MEHANNA, Redmond, WA (US)

(72) Inventors: NICHOLAS ERIC CRASWELL, Seattle, WA (US); NITIN AGRAWAL, Redmond, WA (US); BODO von BILLERBECK, Melbourne (AU); HUSSEIN MOHAMED MEHANNA, Redmond, WA (US)

(73) Assignee: MICROSOFT CORPORATION, Redmond, WA (US)

(21) Appl. No.: 13/526,778

(22) Filed: Jun. 19, 2012

(51) Int. Cl. G06F 17/27

(52) U.S. Cl. 704/9

(57) ABSTRACT

Methods, systems, and media are provided for generating one or more spelling candidates. A query log is received, which contains one or more user-input queries. The user-input queries are divided into one or more common context groups. Each term of the user-input queries is ranked within a common context group according to a frequency of occurrence to form a ranked list for each of the one or more common context groups. A chain algorithm is implemented to the respective ranked lists to identify a base word and a set of one or more subordinate words paired with the base word. The base word and all sets of the subordinate words from all of the respective ranked lists are aggregated to form one or more chains of spelling candidates for the base word.

### BACKGROUND

User web search queries are used to obtain search query results from a search engine. However, many user queries contain misspellings. This could result for many reasons, such as, an unfamiliar subject matter, or the user is entering a name that was heard from radio or television, or the user introduces lexical errors inadvertently while typing.

Misspellings can be corrected using different methods, such as using a dictionary. When a user query term does not appear in a dictionary, a dictionary entry with the lowest edit distance can be used or suggested as an alternative to the misspelled term. The edit distance refers to the number of characters within the misspelled term that need to be added, deleted, or changed in order to achieve a correctly spelled term. For example, “amand” has an edit distance of one, if corrected to “amend.” For another example, “Cincinatti” has an edit distance of two, when corrected to “Cincinnati,” where one letter was added (n) and another letter was removed (t). However, a static dictionary may not contain colloquial terms or many names that are currently popular, which the dictionary may predate. In addition, updating a dictionary typically relies on costly human labor.

Another spell correction system uses dynamic lookup tables of misspelled/corrected pairs. The misspelled query term is altered to the most common term that has a low edit distance from the user query misspelled term. However, the correctly spelled term may have a large edit distance if it was derived from a longer misspelled term. Therefore, a corrected term may be excluded from consideration due to a large edit distance.

A trie is another tool used with some spell correction systems. A trie is an ordered tree data structure that is used to store an associative array, where the keys are usually strings. A trie can be populated with one or more dictionaries, histograms, word bi-grams, or frequently used spellings. However, as with other systems, a corrected term may be excluded from consideration due to a large edit distance.

### SUMMARY

Embodiments of the invention are defined by the claims below. A high-level overview of various embodiments is provided to introduce a summary of the systems, methods, and media that are further described in the detailed description section below. This summary is neither intended to identify key features or essential features of the claimed subject matter, nor is it intended to be used as an aid in isolation to determine the scope of the claimed subject matter.

Systems, methods, and computer-readable storage media are described for generating spelling candidates. In some embodiments, a method of generating one or more spelling candidates includes receiving a text fragment log. The text fragment log is divided into one or more common context groups. Each term or phrase of the divided text fragment log is ranked according to a frequency of occurrence within each of the one or more common context groups to form one or more respective ranked lists. A chain algorithm is implemented to each of the respective ranked lists to identify a base word or phrase and a set of one or more subordinate words or phrases paired with the base word or phrase. The base word or phrase is aggregated with all sets of one or more subordinate words or phrases from all of the respective ranked lists to form one or more resulting chains of spelling candidates for the base word or phrase.

In other embodiments, a spelling candidate generator system contains a context group component, an algorithm component, and an aggregation component. The context group component contains a text fragment log divided into one or more common context groups. The algorithm component contains one or more lists of terms or phrases from the divided text fragment log. The one or more lists of terms or phrases are ranked according to a frequency of occurrence within each respective common context group to obtain individual base words or phrases and one or more associated subordinate words or phrases. The aggregation component contains one or more aggregated pairs of the individual base terms or phrases paired with their associated subordinate terms or phrases.

In yet other embodiments, one or more computer-readable storage media have computer-readable instructions embodied thereon, such that a computing device performs a method of generating one or more spelling candidates upon executing the computer-readable instructions. The method includes receiving a query log, which contains one or more user-input queries. The user-input queries are divided into one or more common context groups. Each term of the user-input queries within a common context group are ranked according to a frequency of occurrence for each of the one or more common context groups to form one or more respective ranked lists. For each respective ranked list, a top-ranked word or phrase is identified as a correctly spelled word or phrase. An edit distance is determined for a next-ranked word or phrase from the top-ranked word or phrase for each respective ranked list. The next-ranked word or phrase is labeled as a misspelling of the top-ranked word or phrase when the edit distance is within a threshold level for each respective ranked list. The top-ranked word or phrase and all sets of one or more next-ranked words or phrases from all of the respective ranked lists are aggregated to form one or more chains of spelling candidates for the top-ranked word or phrase.

### BRIEF DESCRIPTION OF THE DRAWINGS

Illustrative embodiments of the invention are described in detail below, with reference to the attached drawing figures, which are incorporated by reference herein, and wherein:

FIG. 1 is a schematic representation of an exemplary computer operating system used in accordance with embodiments of the invention;

FIG. 2 is a flowchart of a spelling candidate generation method used in accordance with embodiments of the invention;

FIGS. 3a-3c are tables of spelling candidate generation scoring used in accordance with embodiments of the invention;

FIG. 3d is a screenshot used in accordance with embodiments of the invention;

FIG. 4a is a flowchart of a chain algorithm used in accordance with embodiments of the invention;

FIG. 4b is a table of spelling candidate generation scoring used in accordance with embodiments of the invention; and

FIG. 5 is a schematic representation of a spelling candidate generation system used in accordance with embodiments of the invention.

### DETAILED DESCRIPTION

Embodiments of the invention provide systems, methods and computer-readable storage media for spelling candidate generation.

The terms “step,” “block,” etc. might be used herein to connote different acts of methods employed, but the terms should not be interpreted as implying any particular order, unless the order of individual steps, blocks, etc. is explicitly described. Likewise, the term “module,” etc. might be used herein to connote different components of systems employed, but the terms should not be interpreted as implying any particular order, unless the order of individual modules, etc. is explicitly described.

Embodiments of the invention include, without limitation, methods, systems, and sets of computer-executable instructions embodied on one or more computer-readable media. Computer-readable media include both volatile and nonvolatile media, removable and non-removable media, and media readable by a database and various other network devices. By way of example and not limitation, computer-readable storage media comprise media implemented in any method or technology for storing information. Examples of stored information include computer-useable instructions, data structures, program modules, and other data representations. Media examples include, but are not limited to information-delivery media, random access memory (RAM), read-only memory (ROM), electrically erasable programmable read-only memory (EEPROM), flash memory or other memory technology, compact-disc read-only memory (CD-ROM), digital versatile discs (DVD), Blu-ray disc, holographic media or other optical disc storage, magnetic cassettes, magnetic tape, magnetic disk storage, and other magnetic storage devices. These examples of media can be configured to store data momentarily, temporarily, or permanently. The computer-readable media include cooperating or interconnected computer-readable media, which exist exclusively on a processing system or distributed among multiple interconnected processing systems that may be local to, or remote from, the processing system.

Embodiments of the invention may be described in the general context of computer code or machine-useable instructions, including computer-executable instructions such as program modules, being executed by a computing system, or other machine or machines. Generally, program modules including routines, programs, objects, components, data structures, and the like refer to code that perform particular tasks or implement particular data types. Embodiments described herein may be implemented using a variety of system configurations, including handheld devices, consumer electronics, general-purpose computers, more specialty computing devices, etc. Embodiments described herein may also be implemented in distributed computing environments, using remote-processing devices that are linked through a communications network, such as the Internet.

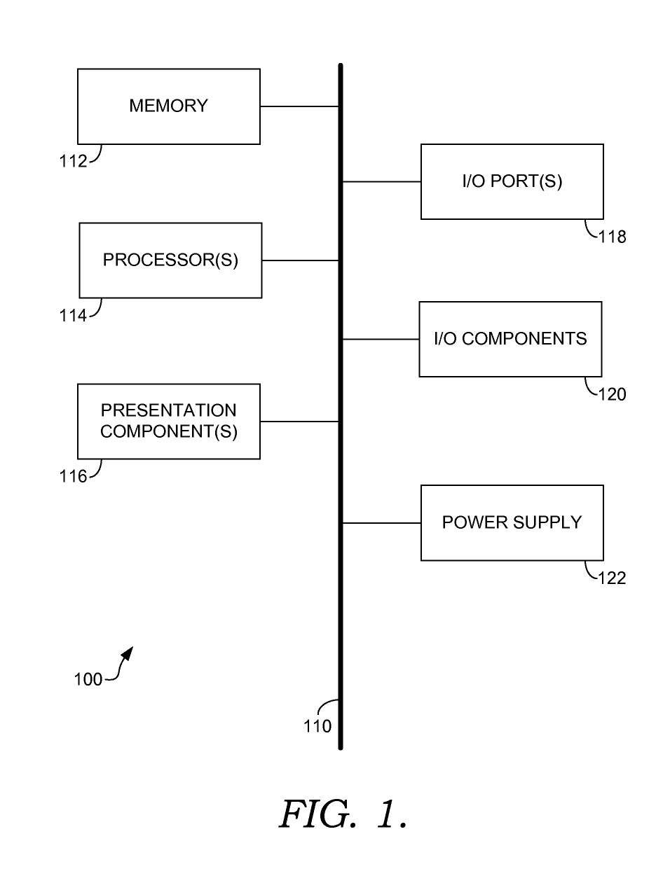

Having briefly described a general overview of the embodiments herein, an exemplary computing system is described below. Referring to FIG. 1, an exemplary operating environment for implementing embodiments of the present invention is shown and designated generally as computing device 100. The computing device 100 is but one example of a suitable computing system and is not intended to suggest any limitation as to the scope of use or functionality of embodiments of the invention. Neither should the computing device 100 be interpreted as having any dependency or requirement relating to any one or combination of components illustrated. In one embodiment, the computing device 100 is a conventional computer (e.g., a personal computer or laptop), having processor, memory, and data storage subsystems. Embodiments of the invention are also applicable to a plurality of interconnected computing devices, such as computing devices 100 (e.g., wireless phone, personal digital assistant, or other handheld devices).

The computing device 100 includes a bus 110 that directly or indirectly couples the following devices: memory 112, one or more processors 114, one or more presentation components 116, input/output (I/O) ports 118, input/output components 120, and an illustrative power supply 122. The bus 110 represents what may be one or more busses (such as an address bus, data bus, or combination thereof). Although the various blocks of FIG. 1 are shown with lines for the sake of clarity, delineating various components in reality is not so clear, and metaphorically, the lines would more accurately be gray and fuzzy. For example, one may consider a presentation component 116 such as a display device to be an I/O component 120. Also, processors 114 have memory 112. It will be understood by those skilled in the art that such is the nature of the art, and as previously mentioned, the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1, and are referenced as “computing device” or “computing system.”

The components described above in relation to the computing device 100 may also be included in a wireless device. A wireless device, as described herein, refers to any type of wireless phone, handheld device, personal digital assistant (PDA), BlackBerry®, smartphone, digital camera, or other mobile devices (aside from a laptop), which communicate wireles sly. One skilled in the art will appreciate that wireless devices will also include a processor and computer-storage media, which perform various functions. Embodiments described herein are applicable to both a computing device and a wireless device. In embodiments, computing devices can also refer to devices which run applications of which images are captured by the camera in a wireless device. The computing system described above is configured to be used with the several computer-implemented methods, systems, and media for spelling candidate generation, generally described above and described in more detail hereinafter.

Embodiments of the invention can be implemented as software instructions executed by one or more processors in a computing device, such as a general purpose computer, cell phone, or gaming console. Alternatively, or in addition, the functionality described herein can be performed, at least in part, by one or more hardware logic components which include, but are not limited to Field-Programmable Gate Arrays (FPGAs), Application Specific Integrated Chips (ASICs), Program-specific Standard Products (ASSPs), Systems-on-a-chip (SOCs), or Complex Programmable Logic Devices (CPLDs).

Input methods for embodiments of the invention may be implemented by a Natural User Interface (NUI). NUI is defined as any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on-screen and adjacent to the screen, air gestures, head and eye tracking, voice and speech, vision, touch, gestures, and machine intelligence. Specific categories of NUI technologies include, but are not limited to touch sensitive displays, voice and speech recognition, intention and goal understanding, motion gesture detection using depth cameras (such as stereoscopic camera systems, infrared camera systems, rgb camera systems and combinations of these), motion gesture detection using accelerometers/gyroscopes, facial recognition, 3D displays, head, eye, and gaze tracking, and immersive augmented reality and virtual reality systems, all of which provide a more natural interface. NUI also includes technologies for sensing brain activity using electric field sensing electrodes.

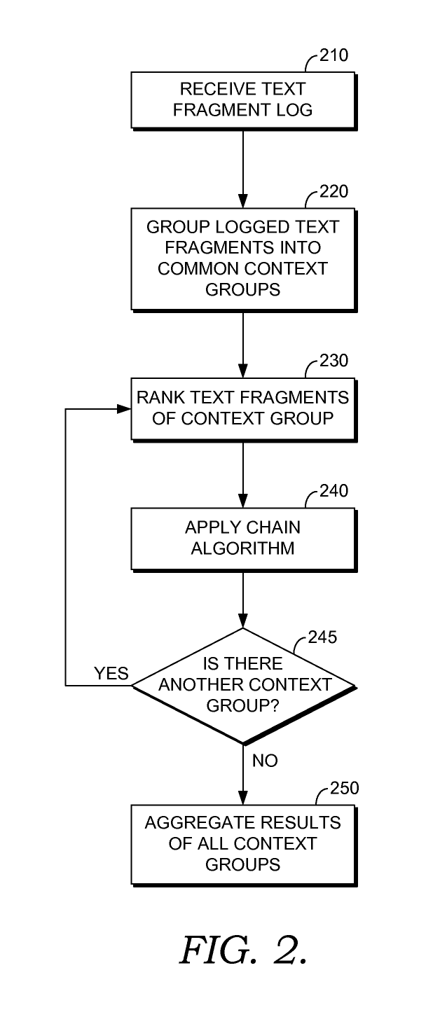

FIG. 2 is a flow diagram for a method of generating one or more spelling candidates. In an embodiment, a search engine receives queries, which are input by users, then returns search results to the users. A log is maintained of the search queries. Another embodiment comprises a log of text fragments, such as anchor text that points to the same URL. Other embodiments of the invention contemplate other common context groups, such as body or title text, or any text fragment that points to the same URL. An index subject category is yet another embodiment of a common context group. A text fragment log is received in step 210. The text fragment log is grouped into common context groups in step 220, where each word or phrase of a text fragment is directed to a common context group. Another embodiment comprises a user-query log grouped into common context groups, such as common Uniform Resource Locators (URLs). A common context could be a single word, a multi-word phrase, or an entire query.

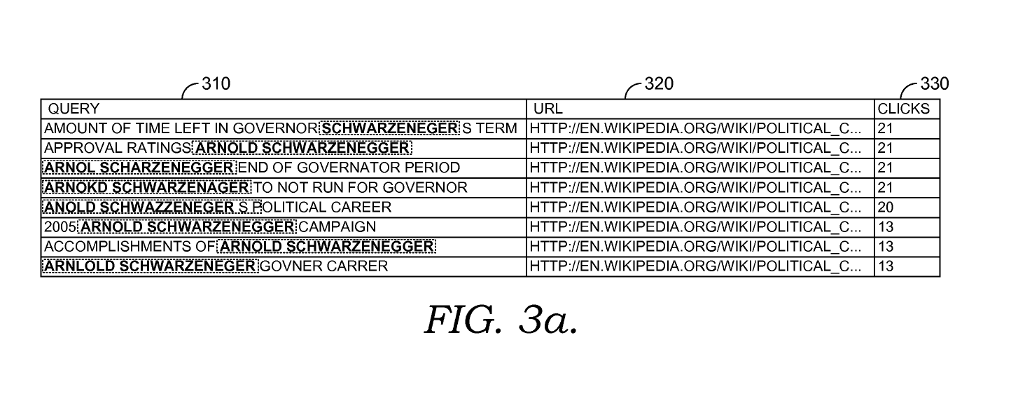

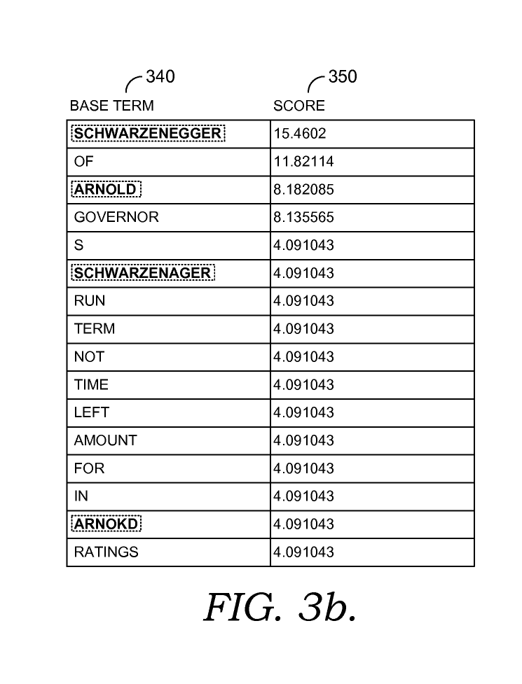

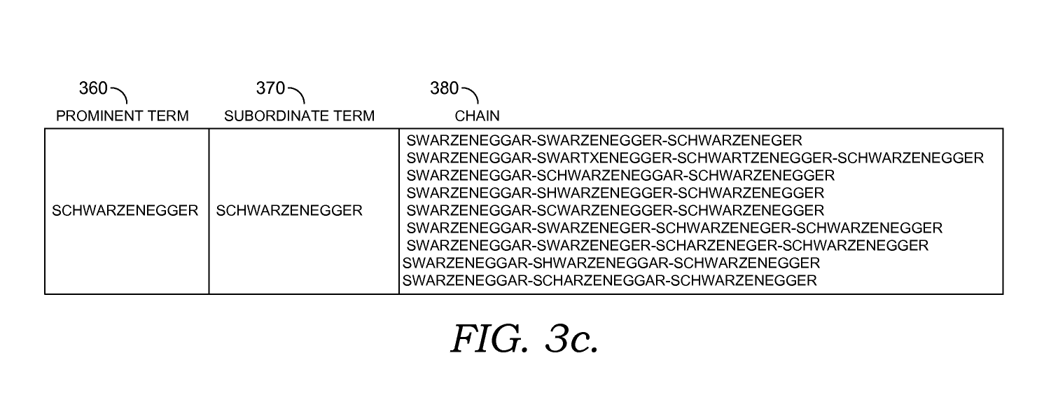

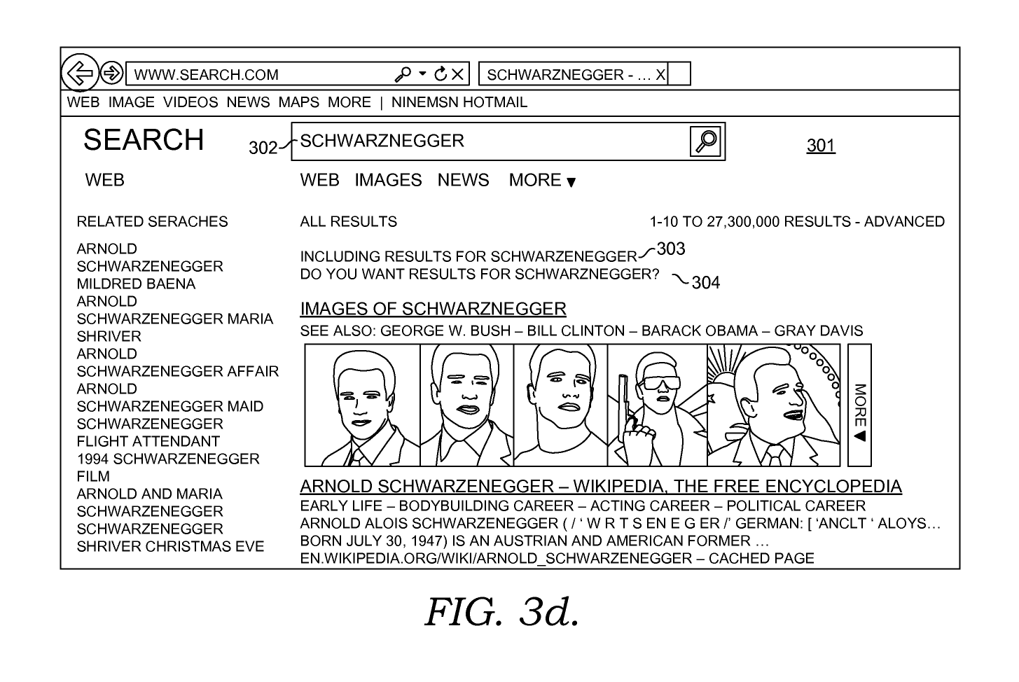

FIG. 3a is a table illustrating several queries 310, where each of the queries resulted in the same URL 320 being clicked upon or selected by the associated user. The table has been truncated, but if the table was expanded, it would illustrate queries that resulted in one or more clicks to the same URL. The number of clicks 330 of each query is also illustrated. FIG. 3a illustrates just one common URL. However, a query log would contain multiple groups of common URLs or other multiple common context groups.

Referring back to FIG. 2, the terms or phrases within the text fragment log are ranked according to their associated frequency of occurrence within each common context group in step 230. An embodiment for calculating the score Λ of a word or phrase uses the total number of clicks for a particular query, θ or some other representative score. The score Λ for each word or phrase can be calculated as:

Λ=Σ[log₁₀(θₙ)+1]

FIG. 3b is a table illustrating ranked results from the commonly grouped URLs illustrated in FIG. 3a. Common context groups other than URLs can also be used, as discussed above. The results in FIG. 3b are sorted for each base term 340 in descending order by a score 350, which is determined as a logarithmic function of the total number of clicks for the associated term, such as the equation above. FIG. 3b is a truncated list and does not include all of the terms from the queries in FIG. 3a.

The top-ranked term or phrase is identified as the prominent term or prominent phrase, then a chain algorithm is applied to determine the edit distance of each term or phrase from the previous term or phrase in step 240. The previous term may be the prominent term or a previous subordinate term. An illustration will be given for step 240, using the information from the tables in FIGS. 3a and 3b. FIG. 3a illustrates a first common context group, which contains a URL from the Wikipedia.org website. The multiple queries contain various spellings and related query terms for the name, “schwarzenegger.” As illustrated in FIG. 3b, the particular spelling of “schwarzenegger” received the highest score. Therefore, the term “schwarzenegger” is assumed to be the correct spelling and is labeled as the dominant term or base word within that particular common context group. FIGS. 3a and 3b both contain alternative spellings for “schwarzenegger,” such as “schwarzenager” and “schwarzeneger.” These alternative spellings are less common terms, as indicated by a lower score. These terms are also assumed to be misspellings of the dominant term, “schwarzenegger,” since there is a small edit distance from the dominant term, “schwarzenegger.” In an embodiment of the invention, an acceptable edit distance is two; therefore, an edit distance of two or less would be considered within a threshold level. However, distances other than edit distances can be used as a threshold level, such as the Damerau-Levenshtein distance. The Damerau-Levenshtein distance is the minimal number of deletion, insertion, substitution, and transposition operations needed to transform one word or phrase to another word or phrase. Any defined distance between words or phrases can be used as a threshold level.

The second highest-ranked term or phrase is selected from the set of words or phrases within the same common context group. In FIG. 3b, that term is “of.” In this particular example, there were no alternative spellings that were associated with “of.” In addition, certain words, such as “of,” “for,” “in,” etc. are not considered to be distinctive or relative to a particular query, and are therefore, not awarded any relevance or weight.

The third highest-ranked term or phrase is selected from the set of words or phrases within the same common context group. In FIG. 3b, that term is “arnold.” FIG. 3b also illustrates another alternative spelling for “arnold,” which is “arnokd.” However, since “arnold” has the higher score, “arnold” is considered to be the dominant term within that particular common context group. The term, “arnokd' has a small edit distance from “arnold,” and is therefore, considered to be a misspelling of “arnold.” The fourth term, “governor” is a very large edit distance from any other term in the list and is not at the end point of a chain. Therefore, “governor” is determined to be correctly spelled. The procedure illustrated above for step 240 is completed for each term or phrase within the ranked list for each common context group.

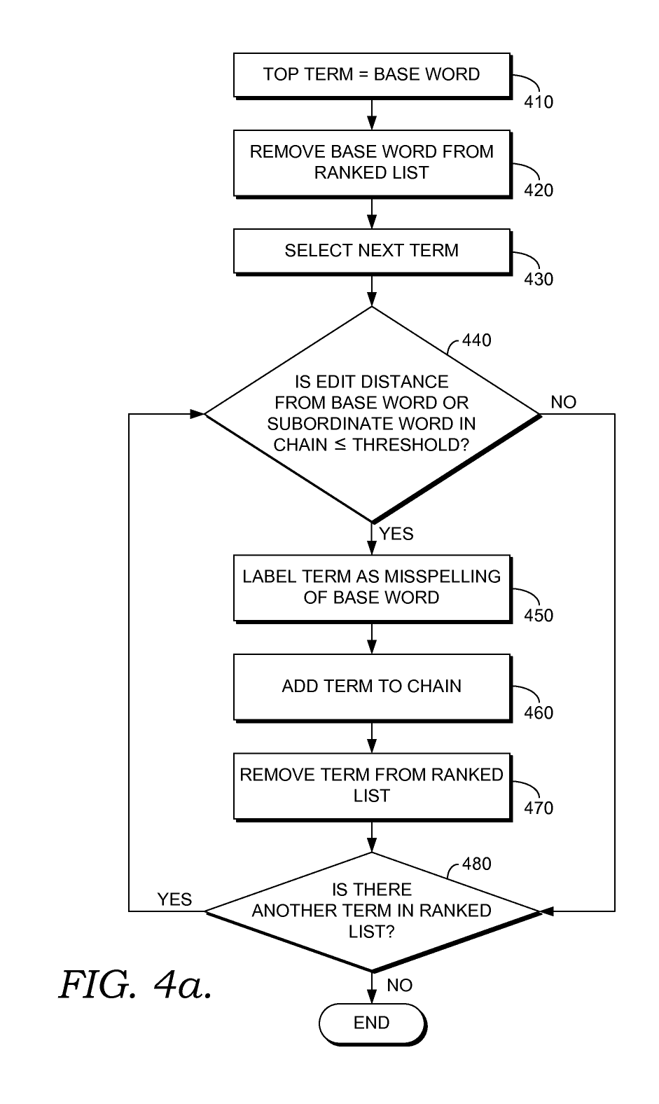

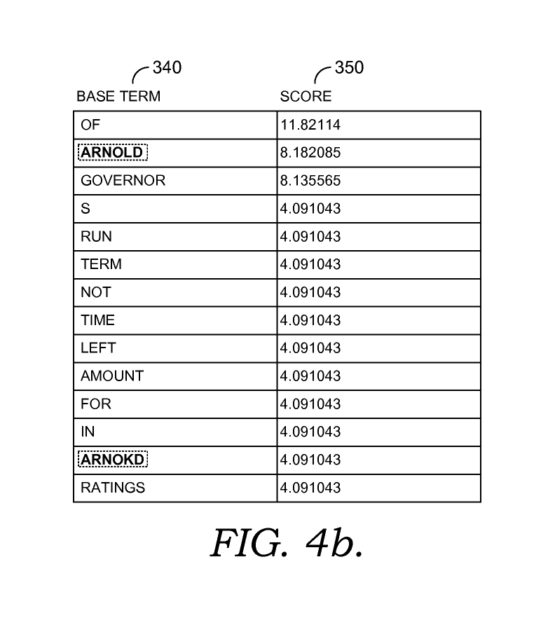

Embodiments of the chain algorithm of step 240 in FIG. 2 produce chains of a dominant term or phrase plus at least one subordinate term or phrase that falls within a threshold edit distance from the dominant term or phrase. Another embodiment produces one or more additional subordinate terms or phrases from the previous subordinate term or phrase. For example, let us assume that “schwarzenegger” is a dominant term. A subordinate term of “swarzenegger” is directly linked to the dominant term, since it is two edit distances away from the dominant term. In an embodiment, two edit distances is within an acceptable threshold, although other edit distances can be selected as a threshold. A second subordinate term, “swarzeneggar” is linked to the first subordinate term, “swarzenegger” because it is within the acceptable threshold edit distance from the previous (first) subordinate term. Therefore, both subordinate terms of “swarzenegger” and “swarzeneggar” are logged as misspellings of the dominant term, “schwarzenegger.” However, if only direct pairs were considered, then the second subordinate term, “swarzeneggar” would not be logged as a misspelling of “schwarzenegger” because the edit distance between the dominant term and the second subordinate term is too large. A more detailed description of the chain algorithm will be given below with reference to FIG. 4a.

In step 245, a determination is made whether there is another context group. If another context group exists, then the method returns to step 230, where the terms or phrases of the subsequent context group are ranked. If there are no more context groups, then the method continues to step 250. In step 250, results for all common context groups are aggregated. The table in FIG. 3c illustrates an embodiment for aggregating a base term with multiple subordinate terms. In the illustrated example, all instances of aggregating the prominent term 360 “schwarzenegger” to the subordinate term 370 “swarzeneggar” are given. All of the resulting chains 380 in the illustrated example contain three or four linked terms. As a result, several additional subordinate terms are retrieved and logged as misspellings of the dominant term. These additional subordinate terms would have been dropped if only two-term pairs (a dominant term and one subordinate term) were considered. FIG. 3c illustrates just one group for a dominant term and a common final subordinate term, with all intermediate subordinate terms. Several similar groupings would be present in FIG. 3c for all queries or text fragments across all common context groups.

The extracted pairs of prominent/subordinate words or phrases can be scored according to the following embodiment. The likelihood of a subordinate term or phrase being a misspelling of the dominant term or phrase is given by the fraction of the number of contexts in which the subordinate term or phrase was corrected to the dominant term or phrase, and the total number of contexts in which the subordinate term or phrase appeared. A mathematical illustration is given below.

Let: Ψ=the total number of common contexts in which one or more queries or text fragments contained a possibly incorrect spelling of a word/phrase (W/P); Φ=the number of common contexts not corrected (considered correct); Ω=the number of common contexts in which a possibly incorrect spelling of a W/P was found to be a misspelled word or phrase of W/P. A common context could be a single word, a multi-word phrase, or an entire query.

Likelihood of original word or phrase being correct=Φ/(Φ+Ψ)

Likelihood of changing W/P to W′/P′=Ω/(Φ+Ψ)

FIG. 3d is an example of how embodiments of the invention can be used in a user interface. A screenshot 301 illustrates a returned result. In this example, a user input the term, “schwarznegger” 302. The total results included results for “schwarzenegger,” 303 (the correct spelling), and also included a question, asking if results for “schwarznegger” were wanted 304.

FIG. 4a is a flow diagram illustrating the chain algorithm discussed above. The chain algorithm is implemented in step 240 of the flow diagram illustrated in FIG. 2. Reference will be made to the tables in FIGS. 3a-3c to specifically illustrate embodiments of the chain algorithm. In step 410, the top ranked term or phrase from the queries or text fragments within the same common context group is selected as the correctly spelled base word or phrase. That base word or phrase is removed from the ranked list in step 420. The next highest term or phrase is selected from the ranked list in step 430. A determination is made in step 440 whether the edit distance of the term or phrase selected in step 430 is within an acceptable threshold edit distance of the base word or phrase. With reference to FIG. 3b, the highest-ranked term is “schwarzenegger,” which is considered to be correctly spelled and is labeled as a base word. The next highest term selected in step 430 from the list in FIG. 3b is “of.” Since the word, “of” is several edit distances away from the base word “schwarzenegger,” it is not within the established threshold edit distance in step 440. In this example, the algorithm would go to step 480, where it is determined whether there is another term or phrase in the ranked list. If another term or phrase exists within the ranked list, then the algorithm returns to step 440.

In the ranked list of FIG. 3b, the terms of, “arnold,” “governor,” and “s” would not fall within the threshold level of two edit distances from “schwarzenegger.” However, the sixth term in FIG. 3b, “schwarzenager” does fall within the threshold level of two edit distances from “schwarzenegger.” Therefore, “schwarzenager” is labeled as a misspelled term of the base word, “schwarzenegger” in step 450. The misspelled term of “schwarzenager” is added to the chain in step 460. When a term is added to a new or existing chain, it is removed from the ranked list in step 470. FIG. 4b illustrates the table of FIG. 3b, where “schwarzenegger” has been removed in step 420, and “schwarzenager” has been removed in step 470. A determination is made in step 480 whether another term exists in the ranked list. If there is still another term in the ranked list, then the algorithm returns to step 440, where a determination is made whether the newly selected term falls within a threshold edit distance of the base word of previous misspelling of the base word. Continuing with the example of FIG. 3b, none of the remaining terms would fall within a threshold edit distance of two from the base word. Therefore, the algorithm would end because there are no more terms remaining in the ranked list.

The chain algorithm illustrated in FIG. 4a is repeated for each ranked list of terms or phrases associated with a common context group for any number of common context groups, n. For example, the chain algorithm would be repeated ten times if there were ten common context groups. After the chain algorithm has been applied to all common context groups, the flow diagram of FIG. 2 aggregates the results in step 250, as discussed above.

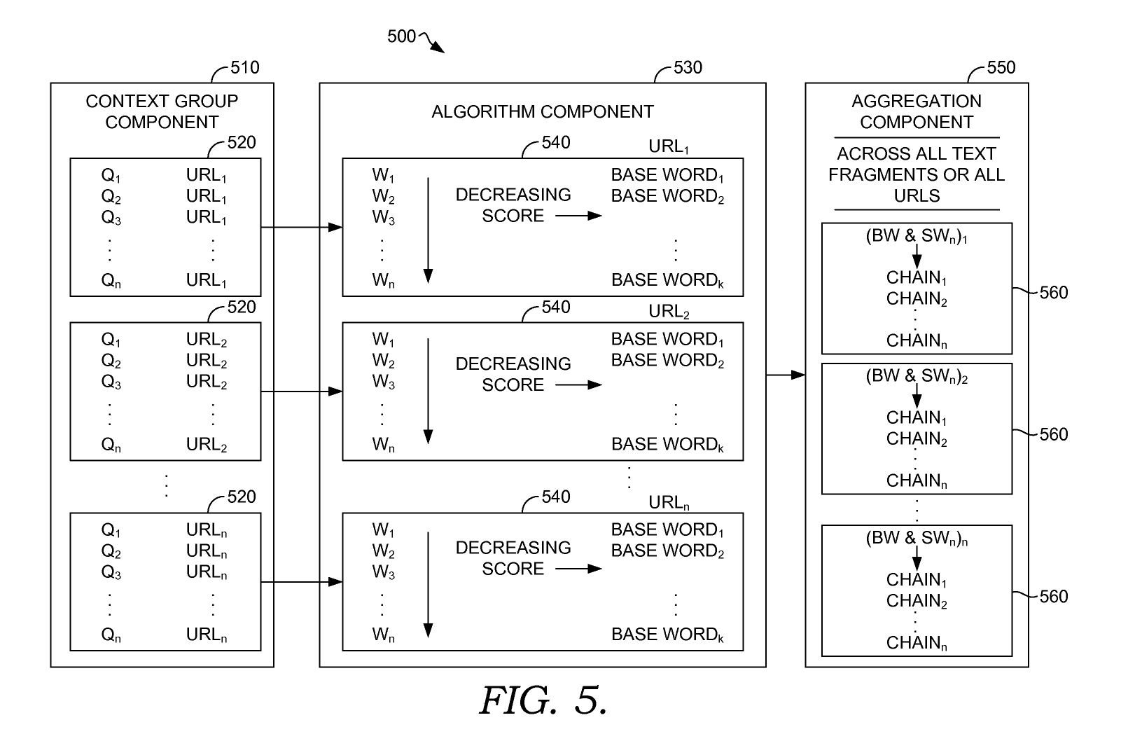

FIG. 5 is a block diagram illustrating a spelling candidate generation system 500. The spelling candidate generation system 500 contains a context group component 510. The context group component 510 contains an individual block for each common context group 520, such as individual URL groups. However, other common context groups can be used. An alternative embodiment uses a particular subject category, such as an index category instead of a URL for each of the common context groups 520. Each common context group 520 contains all of the queries, that when clicked upon or selected, lead to that particular common context group, such as a specific URL.

The spelling candidate generation system 500 also contains an algorithm component 530. Each of the common context groups 520 in the context group component 510 are ranked within their respective common context groups 520 according to frequency of occurrence. Therefore, the first common context group 520 within the context group component 510 will have a corresponding ranked list 540 within the algorithm component 530. The table in FIG. 3a is an example of one common context group 520, and the table in FIG. 3b is an example of one ranked list 540. An embodiment of the invention ranks the terms in each ranked list 540 by decreasing score, but the ranked list could also be grouped in ascending score order.

The chain algorithm, discussed above with reference to FIG. 4a, is applied to each word or phrase within each ranked list 540. The chain algorithm is used to obtain a base word or phrase, which may have one or more subordinate terms. From the abbreviated list of ranked terms in FIG. 3b, two chains result. “Schwarzenegger” is the first base word, which is chained to a first subordinate term, “schwarzenager.” “Arnold” is the second base word, which is chained to a first subordinate term, “arnokd.” The remaining terms in FIG. 3b do not have any subordinate terms chained to them.

The spelling candidate generation system 500 also contains an aggregation component 550. The aggregation component 550 combines the pairs of base words or phrases with associated subordinate words or phrases. An alternative embodiment combines pairs of correctly spelled words or phrases with associated variantly or incorrectly spelled words or phrases. Aggregated pairs are formed from all of the individual ranked lists 540 for all of the common context groups 520. The aggregation component 550 forms one or more chains 560 for each base word (BW) and its associated one or more subordinate words (SWₙ). FIG. 3c illustrates the chains resulting from combining the base word, “schwarzenegger” and the subordinate word, “swarzeneggar.”

In a conventional spelling candidate generator, “swarzeneggar” would probably not be linked to “schwarzenegger” because “swarzeneggar” is three edit distances away from “schwarzenegger.” However, embodiments of the invention provide one or more intermediate subordinate terms to be chained to the base word, wherein each subordinate term falls within an acceptable threshold edit distance from the most previous term, either the base word or another subordinate word. As a result, each term within a chain can be logged as a linked misspelling of the base word. FIG. 3c illustrates chains containing two to three subordinate words of the base word, “schwarzenegger.” The resulting chains contain many misspelled pairs that would not have been included outside of embodiments of the invention.

Many different arrangements of the various components depicted, as well as embodiments not shown, are possible without departing from the spirit and scope of the invention. Embodiments of the invention have been described with the intent to be illustrative rather than restrictive.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A computer-implemented method of generating one or more spelling candidates, using a computing system having a processor, memory, and data storage unit, the computer-implemented method comprising:
receiving a text fragment log;
dividing the text fragment log into one or more common context groups;
ranking, via the processor unit, each term or phrase of the divided text fragment log according to frequency of occurrence within each of the one or more common context groups to form one or more respective ranked lists;
implementing a chain algorithm to each of the one or more respective ranked lists to identify a base word or phrase and a set of one or more subordinate words or phrases paired with the base word or phrase; and
aggregating the base word or phrase and all sets of one or more subordinate words or phrases from all of the respective ranked lists to form one or more resulting chains of spelling candidates for the base word or phrase.

2. The computer-implemented method of claim 1, wherein the one or more common context groups each comprise a Uniform Resource Locator (URL).

3. The computer-implemented method of claim 1, wherein the one or more common context groups each comprise an index subject category.

4. The computer-implemented method of claim 1, wherein the base word or phrase comprises a most frequently occurring word or phrase within its ranked list.

5. The computer-implemented method of claim 4, wherein the set of one or more subordinate words or phrases comprises a first subordinate word or phrase within a threshold edit distance from the base word or phrase and a second subordinate word or phrase within a threshold edit distance from the first subordinate word or phrase.

6. A computer-implemented spelling candidate generator system using a computing device having a processor, memory, and data storage unit, the computer-implemented system comprising:
a context group component containing a text fragment log divided into one or more common context groups;
an algorithm component containing one or more lists of terms or phrases from the divided text fragment log, the one or more lists of terms or phrases ranked by the processor unit according to frequency of occurrence within each respective common context group to obtain individual base words or phrases and one or more associated subordinate words or phrases; and
an aggregation component containing one or more aggregated pairs of the individual base terms or phrases paired with their associated subordinate terms or phrases.

7. The computer-implemented system of claim 6, wherein the aggregation component contains resulting chains from all of the one or more ranked lists of terms or phrases for a base term or phrase and its paired subordinate terms or phrases.

8. The computer-implemented system of claim 7, wherein the paired subordinate terms or phrases comprise a first subordinate term or phrase within a threshold edit distance from the base term or phrase and a second subordinate term or phrase within a threshold edit distance from the first subordinate term or phrase.

9. The computer-implemented system of claim 6, wherein the base term or phrase comprises a most frequently occurring term or phrase within its respective ranked list.

10. The computer-implemented system of claim 6, wherein the common context groups comprise anchor text.

11. The computer-implemented system of claim 6, wherein the common context groups comprise body text.

12. The computer-implemented system of claim 6, wherein the common context groups comprise title text.

13. One or more computer-readable storage media storing computer readable instructions embodied thereon, that when executed by a computing device, perform a method of generating one or more spelling candidates, the method comprising:
receiving a query log, comprising one or more user-input queries;
dividing the user-input queries into one or more common context groups;
ranking each term of the user-input queries within a common context group according to frequency of occurrence for each of the one or more common context groups to form one or more respective ranked lists;
for each respective ranked list:
identifying a top-ranked word or phrase as a correctly spelled word or phrase;
determining an edit distance of a next-ranked word or phrase from the top-ranked word or phrase; and
labeling the next-ranked word or phrase as a misspelling of the top-ranked word or phrase when the edit distance is within a threshold level; and
aggregating the top-ranked word or phrase and all sets of one or more next-ranked words or phrases from all of the respective ranked lists to form one or more chains of spelling candidates for the top-ranked word or phrase.

14. The one or more computer-readable storage media of claim 13, further comprising:
determining an edit distance of a second next-ranked word or phrase from the next-ranked word or phrase; and
labeling the second next-ranked word or phrase as a misspelling of the top-ranked word or phrase when the edit distance of the second next-ranked word or phrase is within a threshold level of the next-ranked word or phrase.

15. The one or more computer-readable storage media of claim 13, wherein the one or more common context groups each comprise a Uniform Resource Locator (URL).

16. The one or more computer-readable storage media of claim 13, wherein the one or more common context groups each comprise an index subject category.

17. The one or more computer-readable storage media of claim 13, further comprising:
removing the top-ranked word or phrase and all next-ranked words or phrases that fall within the threshold level;
identifying a new top-ranked word or phrase within the respective ranked list;
determining an edit distance of a next-ranked word or phrase from the new top-ranked word or phrase; and
labeling the next-ranked word or phrase as a misspelling of the new top-ranked word or phrase when the edit distance is within a threshold level.

18. The one or more computer-readable storage media of claim 13, wherein the one or more chains are ranked according to a fraction of a number of contexts in which the next-ranked word or phrase was corrected to the top-ranked word or phrase, and the total number of contexts in which the next-ranked word or phrase appeared.

19. The one or more computer-readable storage media of claim 13, wherein the edit distance comprises a number of characters that need to be added, deleted, or changed to match the top-ranked word or phrase.

20. The one or more computer-readable storage media of claim 13, wherein the common context groups comprise one of anchor text, body text, or title text.
